(19) United States
(12) Patent Application Publication
(10) Pub. No.: US 2005/0075912 A1
(43) Pub. Date: Apr. 7, 2005

(54) Computerized settlement method

(76) Inventors: Bruce B. Bealke, Valley Village, CA (US); Lawrence W. Shea II, La Jolla, CA (US)

Correspondence Address: ROBERT R. THORNTON, 3264 MEADOWLARK LANE, CARLSBAD, CA, 92008-2024, US

(21) Appl. No.: 10/680,808

(22) Filed: Oct. 6, 2003

(51) Int. Cl. G06F 17/60; H04L 9/00; H04L 9/32; G06F 11/30; G06F 12/14

(52) U.S. Cl. 705/4; 705/1; 713/200

(57) ABSTRACT

The present invention relates to the settlements of disputes and, in particular, offers insurance carriers, self-insured entities, and claimants the ability to formulate, review and electronically execute claims settlements, including releases, and for providing electronic funds transfer instructions for immediate release of settlement funds. In the preferred embodiment, in order to maintain confidentiality, an independent intermediary entity is utilized to receive the proposed settlement terms and their acceptance, electronically receive the execution of any release, and to coordinate electronic transfer of settlement funds after acceptance and electronic execution of any release, thereby reducing the time for completion of the entire transaction to less than two business days. In a further embodiment of the invention, the independent intermediary accumulates the settlement details and compiles a database of such information, which is accessible to claimants and insurers on a selective basis to assist in the evaluation of claims for settlement purposes, based on the settlement values of prior claims involving similar circumstances, and, preferably, is utilized by the insurance carriers, self-insured entities, and/or claimants prior to formulation of and/or acceptance of a claim settlement proposal to assist in evaluating the claim.

### FIELD OF INVENTION

This invention generally relates to computerized systems for the electronic execution of settlements of claims, including the automated electronic disbursal of settlement funds according to the terms of electronically executed settlement documentation. This invention also relates to a computerized system for statistical compilation of data related to settlements processed using the system of the present invention and allows the subsequent selective dissemination of settlement data compiled by the system.

### BACKGROUND OF THE INVENTION

The property/casualty insurance industry currently faces at least one hundred million claims every year. When combined with other large entities that self-insure, it is estimated that the number of “insurance” type claims currently exceeds two hundred million per year nationally.

Attorneys who represent plaintiffs in the property/casualty claim field are typically compensated on a contingency basis at the successful conclusion of the case. Those plaintiff attorneys are therefore dependent upon a steady stream of cash flow. Property/casualty claims normally settle quickly, with a release required to be signed by or on behalf of the claimant and a settlement payment funded by a check issued to the claimant or the claimant's representative. There is typically a delay in sending settlement funds to claimants pending receipt by the party funding the settlement or its representative of the executed settlement documents, normally including a fully executed Release. The current process for executing the Release and disbursing a settlement check may take from ten to twenty-one days. Since claims typically are filed by individuals and, with the exception of worker's compensation, health insurance and similar matters, are not recurring, it is not cost effective for insurers to maintain a historical database with wiring instructions pertaining to individual claimants. Also, given the adversarial nature of the claims process, claimants and/or their counsel or other representatives typically do not want to provide personal information which is not required for the settlement, such as where they bank, to insurers or their representatives. In addition, the cost to the entity actually making the payment by issuing the physical check currently is approximately twenty-five to fifty dollars per check.

The settlement process is further delayed by the fact that there is currently no independent means for plaintiffs' attorneys or insurers to readily determine the settlement value of their cases based on independent, verifiable statistics based on prior settlements of comparable claims. Consequently, plaintiffs' attorneys and insurers rely principally on their own experience or anecdotal evidence. Consequently, a procedure by which plaintiffs' attorneys and insurers are able to better value the settlement range for particular types of claims is needed to expedite claim settlement and reduce litigation costs.

### SUMMARY OF THE INVENTION

The present invention offers insurance carriers, self-insured entities, and claimants the ability to electronically review proposed settlement terms and electronically execute Releases while simultaneously providing wiring instructions for immediate electronic transfer of settlement funds. In the preferred embodiment, in order to maintain confidentiality, an independent intermediary entity is utilized to receive proposed settlement terms, electronically receive the execution of the Release, and coordinate the electronic transfer of the settlement funds in accordance with the claimant's instructions after execution of the Release, thereby enabling the time required for completion of the entire settlement transaction to be reduced to less than two full business days.

According to the present invention, in a dispute including a first party and a second party and involving the disbursal of funds for its settlement, the first party communicates terms of and participants in a monetary settlement to a third party, the third party assigns a unique identifying designator to the settlement terms and participants, the third party makes the settlement terms available for access by the second party over an electronic network by use of the designator and the designator is communicated to the second party, the second party uses the designator to electronically access the settlement terms, the second party electronically transmits either a settlement terms acceptance communication or a settlement terms refusal communication to the third party, and the third party, upon receiving the acceptance communication or the refusal communication from the second party, either causes the settlement to be funded by electronic funds transfer from a source designated by the first party if the communication is an acceptance communication and notifies the parties of the acceptance and funds disbursal, or, if the communication is a refusal communication, notifies the first party of the refusal.

In a further embodiment of the invention, the third party accumulates settlement details for settlements effectuated by the third party through use of the present invention and compiles a database of such information, which is then accessible on a selective basis by a participant in a new dispute to assist in the evaluation of the new dispute for settlement purposes, based on the settlement details of prior disputes involving comparable circumstances.

### BRIEF DESCRIPTION OF THE DRAWING

FIG. 1 is a block diagram illustrating the overall steps in the practice of the method of the present invention in settling a dispute between a first party and a second party, in which the terms and acceptance of the settlement are communicated through a third party;

FIG. 2 is a block diagram, similar to FIG. 1, and illustrating the communication of the settlement terms initiated by the first party through a third party and its acceptance or rejection by the second party;

FIG. 3 is a block diagram illustrating, for the preferred embodiment of the present invention, paths for the flow of information between the parties in the overall settlement method according to the present invention, including the retention of settlement information in a proprietary database for later access by database subscribers;

FIG. 4, FIG. 4A, FIG. 4B AND FIG. 4C being taken together, is a block diagram illustrating details of the steps in the practice of the present invention illustrated in FIGS. 1 through 3;

FIG. 5 is a block diagram illustrating the steps of the invention in the accessing of the database by the database subscribers; and

FIG. 6 is a block diagram illustrating the practice of the present invention from an initial accessing of the database in order to obtain prior settlement information to assist in the formulation of a settlement proposal through the transmission of the settlement proposal, its acceptance or rejection, and the consummation of the settlement if the proposal is accepted.

### DETAILED DESCRIPTION OF THE INVENTION

Although certain of the embodiment descriptions which follow employ an insurance claim settlement method for purposes of illustration, those skilled in the art will understand that the scope of the present invention is not limited thereto in its broadest aspects. Accordingly, the use of terms such as “claimant,” “claimant's attorney”, “plaintiff's or plaintiffs' attorney,” “insurer,” “carrier,”and “claims representative” refer to the participants in a settlement of a claim for monetary damages, as to which the utilization of the methods of the present invention are particularly advantageous with respect to the methods of the prior art, and are to be understood to be for illustrative purposes, rather than being terms of limitation, unless otherwise indicated.

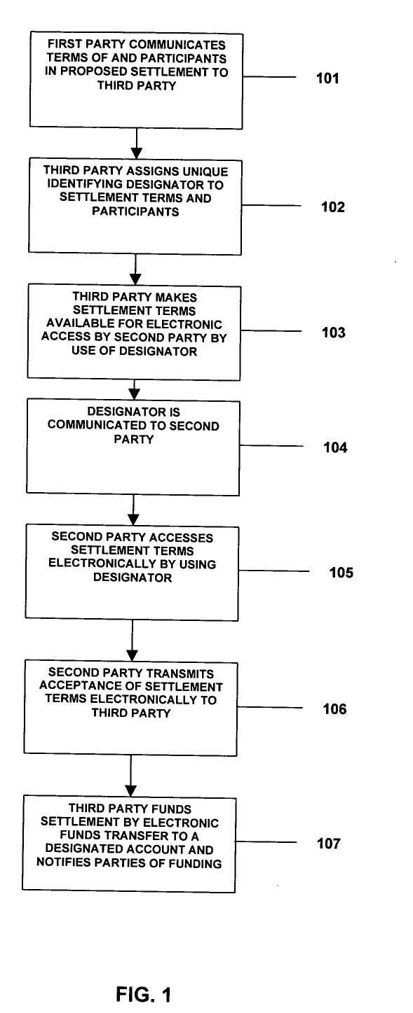

Referring now to FIG. 1, a method for funding a resolution of a dispute is shown in block diagram form illustrating the steps of the method. In FIG. 1, it is assumed that the dispute is between a first party and a second party. In the first step, illustrated as Block 101, the first party communicates the terms of a proposed settlement, including any conditions for acceptance of the proposed settlement, to a third party, preferably not a real party in interest to the dispute. In the second step, illustrated as Block 102, the third party assigns a unique designator to the settlement terms and participants, including any conditions, communicated to the third party by the first party. In the third step, illustrated as Block 103, the third party makes the settlement terms, including any conditions, available for electronic access by the second party, as, for example by access through a quasi-public network such as the Internet, by use by the second party of the unique designator assigned by the third party to the settlement terms. In the fourth step, illustrated in Block 104, the unique designator is communicated to the second party. Such communication is made by or through either the third party or the first party, and preferably is made by a method with at least some security, such as a direct telephone call, an encrypted email message, a facsimile transmission or other direct written delivery, to avoid ready access to the terms by others not involved in the dispute. For example, the third party may provide the designator to the first party, who, in turn, telephonically transmits it to the second party. In the fifth step, illustrated in Block 105, the second party accesses the settlement terms electronically by using the designator, so that the security of the terms is preserved, as access to the terms is denied to those not possessing the unique designator information. In the sixth step, illustrated in Block 106, the second party, having considered the settlement terms accessed by using the unique designator, electronically transmits an acceptance of the terms to the third party, preferably through the same network by which access was achieved. In the seventh step, illustrated in Block 107, the third party funds the settlement after receiving the acceptance by the second party of the terms, by the electronic transfer of the settlement funds to an account designated by the party receiving the funds after receiving a release electronically executed by that party, if required by the terms of the settlement, and notifies at least the party providing the source of the funds, and preferably both the first and second parties, of the funding of the settlement, accompanied by a copy of the electronically executed Release. In this example, either the first party or the second party can be the party initiating the settlement proposal.

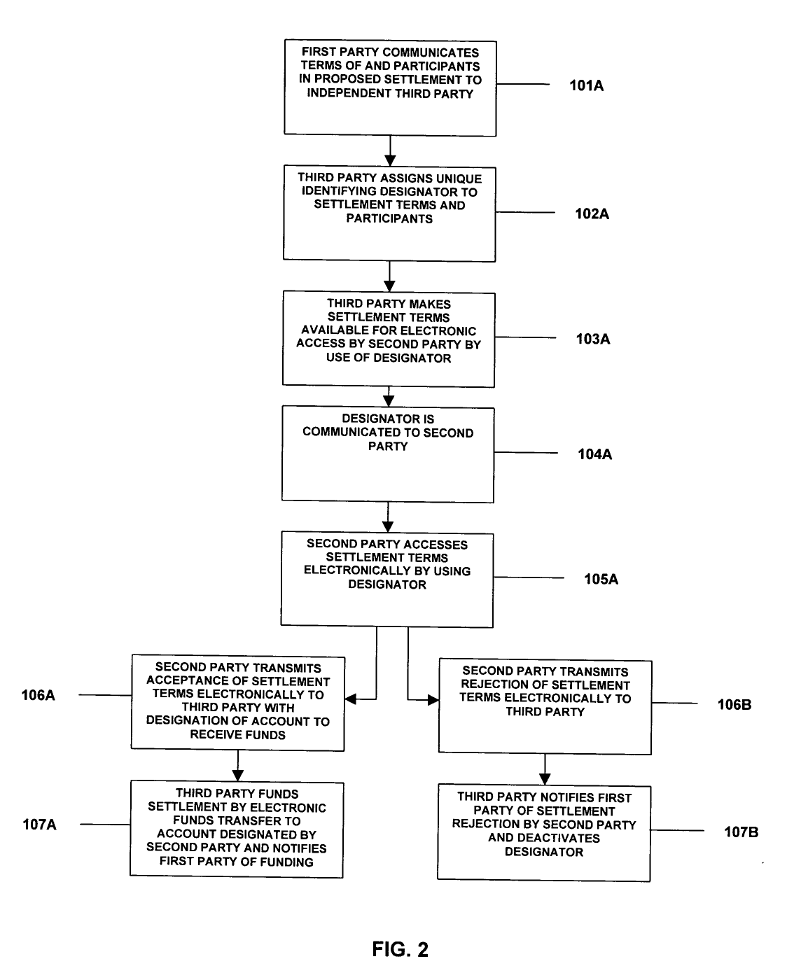

Referring now to FIG. 2, a variation of the method of FIG. 1 is illustrated in block diagram form. In FIG. 2, by way of example, a first party is a representative of an insurance carrier (insurer), and a second party is a claimant, or a representative of the claimant, asserting a claim for monetary damages against the first party, the claim being based on an insurance policy issued by the first party. In FIG. 2, a third party, which in the preferred embodiment is independent of either of the other parties or their representatives, is designated by at least one of the other parties to facilitate settlement and funding of the settlement by maintaining the confidences of each of the other parties. The terms “first party” and “second party” are to be understood to represent the opposing sides to the controversy, and each may, in actuality, be multiple individuals or entities.

FIG. 2, illustrates the steps in a method for reaching and funding a resolution of a dispute in block diagram form, which method is a modification of the method illustrated in FIG. 1. In the first step of the method of FIG. 2, illustrated as Block 101A, the first party, for purposes of illustration assumed to be the insurer, communicates the terms of the proposed settlement, including any conditions for acceptance of the proposed settlement such as execution of a form of a Release, and a source of the funds to be used for funding the settlement, to the independent third party. In the second step, illustrated as Block 102A, the third party assigns a unique designator to the settlement terms and participants, including any conditions and other information, communicated to the third party by the first party. In the third step, illustrated as Block 103A, the third party makes the settlement terms, including any conditions, available for electronic access by the second party, for purposes of illustration assumed to be the claimant as, for example by access through a quasi-public network such as the Internet, by use by the claimant of the unique designator assigned by the third party to the proposed settlement terms. In the fourth step, illustrated in Block 104A, the unique designator is communicated to the claimant. In the fifth step, illustrated in Block 105A, the claimant accesses the settlement terms electronically over a secure network by using the designator, so that the security of the terms is preserved and access to the terms is denied to those not possessing the unique designator information. The claimant then has the alternatives of either accepting or rejecting the settlement terms.

If the claimant accepts the settlement terms, in the sixth step, illustrated in Block 106A, the claimant transmits an acceptance on the terms electronically to the third party together with a designation of an account to receive the settlement funding by an electronic transfer of the settlement funds and an electronic execution of the Release. In the seventh step, illustrated in Block 107A, the third party funds the settlement after receiving the acceptance by the claimant of the terms and the executed Release, by the electronic transfer of the settlement funds from an account designated by the insurer to an account designated by the claimant, and notifies at least the insurer, and preferably both parties, of the funding of the settlement. If the claimant rejects the settlement terms, in the sixth step, illustrated in Block 106B, the claimant electronically transmits a rejection of the settlement terms to the third party. In the seventh step, illustrated in Block 107B, the third party notifies the insurer of the rejection by the claimant and deactivates access to the unique designator.

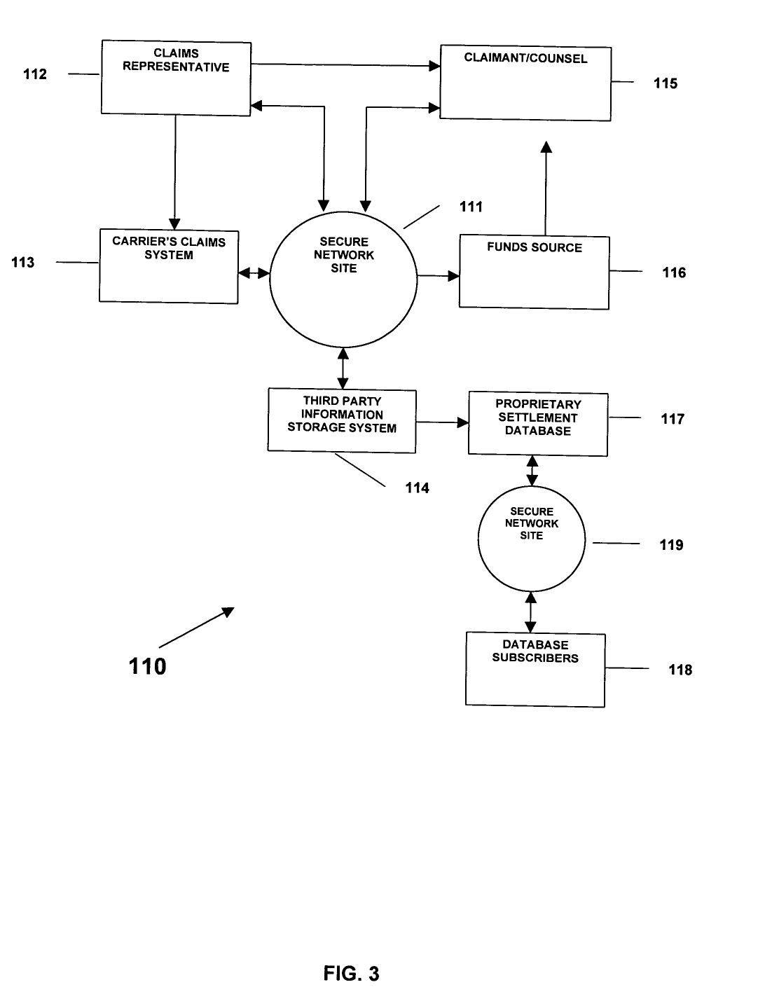

Referring now to FIG. 3, there is shown, in block diagram form, a flow diagram for the transfer of information by a system 110 for the practice of the present invention, specifically adapted for use with a secure network site 111, through which a program of an independent third party is accessed to effect settlement of insurance claims by interaction between an insurance carrier's claims representative 112, and a claimant or a claimant's counsel 115 (hereinafter, collectively, “claimant/counsel 115”).

The claims representative 112, either unilaterally or after conferring with the claimant/counsel 115, enters proposed settlement terms and conditions, either into the carrier's computerized claims system 113, or into an information storage and processing system 114 containing the third party's program, which may be accessed through the network site 111 by the claimant/counsel 115. If the claims representative 112 enters the settlement information into the carrier's claims system 113, the carrier's system 113 communicates directly with the information storage system 114 for the network site 111 to effect an automatic transfer of the settlement data between the two systems 111, 114. After receiving the settlement terms and conditions, the third party program storage system 114 assigns a unique designator to the settlement terms and conditions, containing criteria which the claimant/counsel 115 will be required to provide, edit or confirm in order to access the proposed settlement through the network site 111. The unique designator is communicated to the claimant/counsel 115, preferably by the claims representative 112 who has received it from the system 114.

The claimant/counsel 115 then accesses the system 114 via the network site 111, and either accepts or refuses the settlement terms, which acceptance or refusal is communicated by the system 114 to the claims representative 112 or claims system 113 by the system 114 through the network site 111. If the communication is an acceptance, which requires the electronic execution by the claimant/counsel of a Release, the system transmits the Release to the claims representative 112 or to the claims system 113 and initiates the funding of the settlement by the electronic transfer of funds from a funds source 116 according to instructions received from the claimant/counsel 115, notifies the parties of the funding, and terminates access to the unique designator. The source of funds 116 may be any account designated by the claims representative 112 or the carrier as a source of funds from which the settlement funds are authorized to be electronically transferred by the system 114 to effect the settlement.

The third party system 114 transmits the details of the settlement to a proprietary settlement database 117, which may be a part of the system 114 but for purposes of illustration is shown as a separate database, and in which details of settlements processed by the system 114 are accumulated. The settlement database 117 is subsequently accessed by database subscribers 118, who may, but need not necessarily, include the carrier and/or the plaintiffs' attorney involved in the present dispute just settled, through a secure network site 119, which preferably, but not necessarily, is not the same network site as the secure network site 111, to obtain information as to settlements with respect to comparable disputes, the information as to which has been stored in the database 117. The subscriber 118 sends the details of a new dispute to the database 117, with a request for a report containing the details of settlements of comparable disputes. The database 117 is searched for such comparable dispute settlements, and reports from the database 117 of the details of such comparable settlement are electronically transmitted to the subscriber 118 over the secure network site 119 either directly from the database 117 or through the system 114 to the subscriber 118 to enable to subscriber 118 to better evaluate the settlement value of the new dispute by comparing the details of the new dispute to the details of the settlements of comparable disputes previously stored in the database 117.

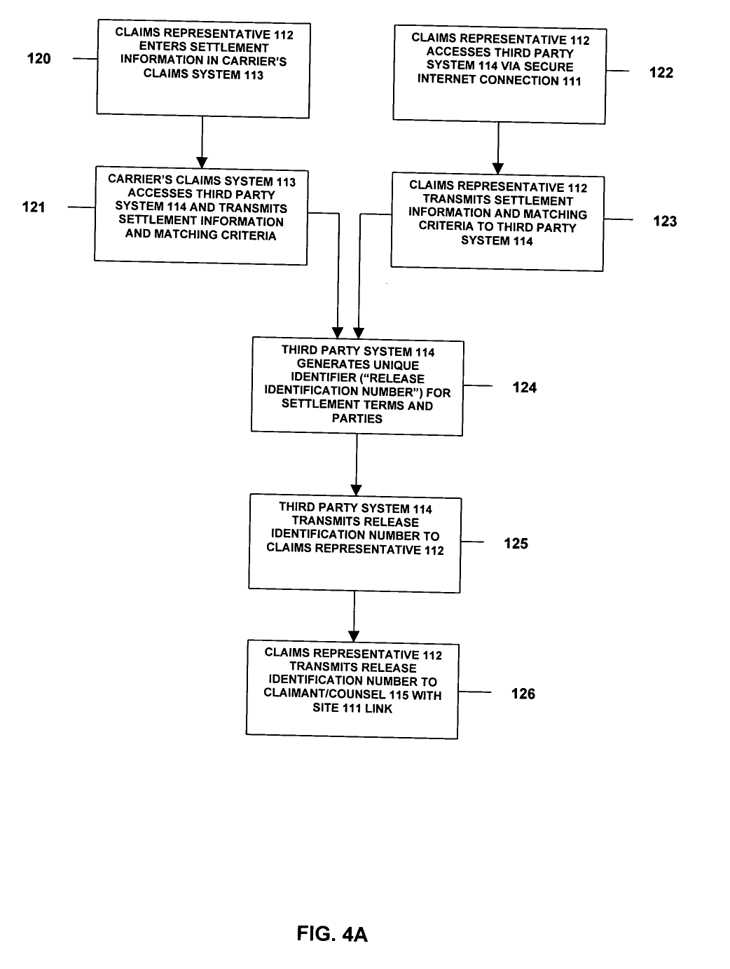

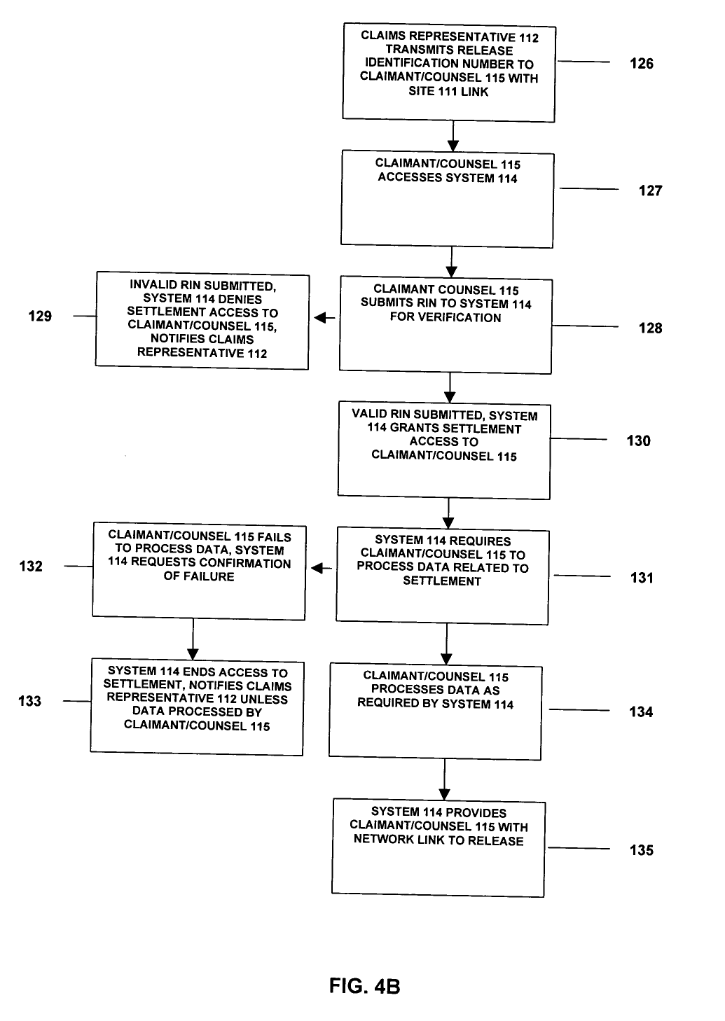

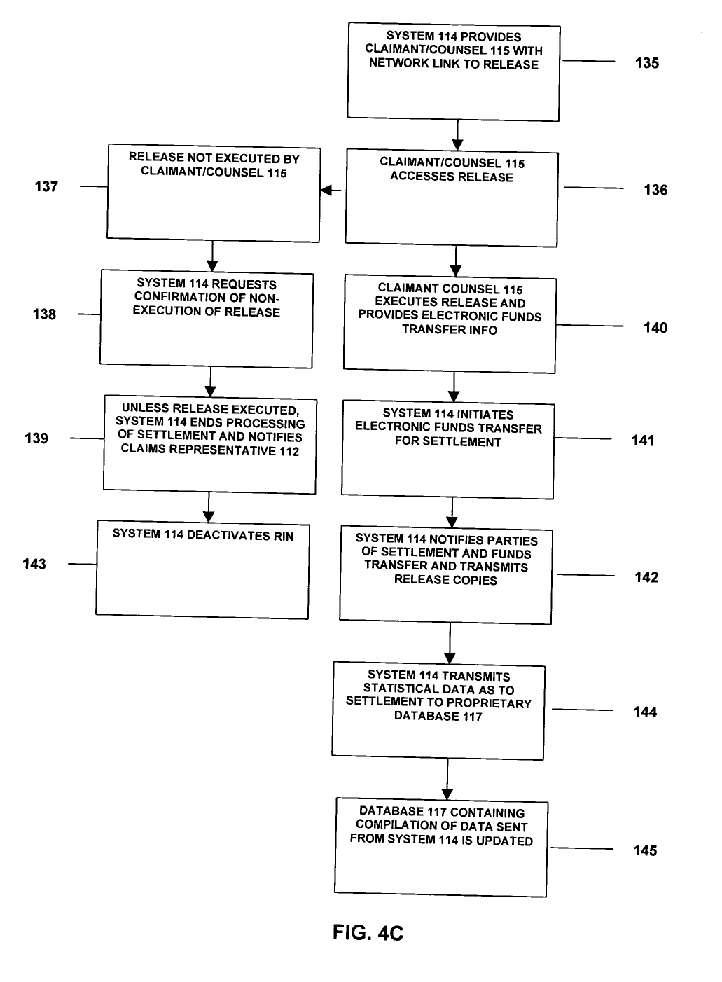

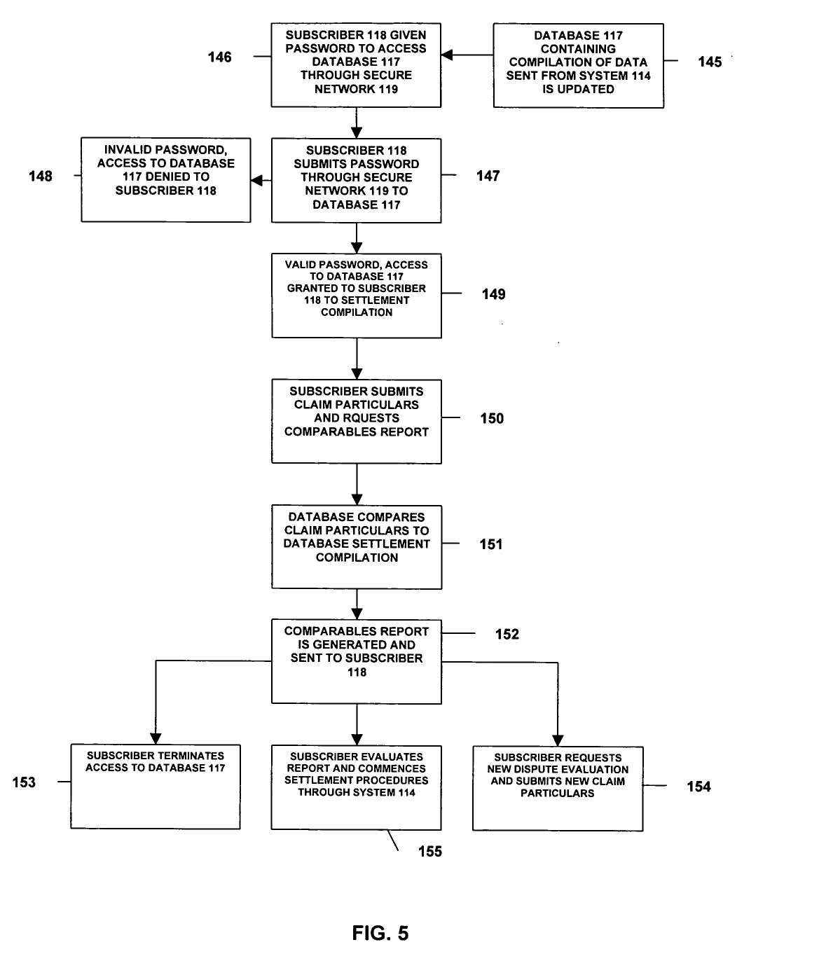

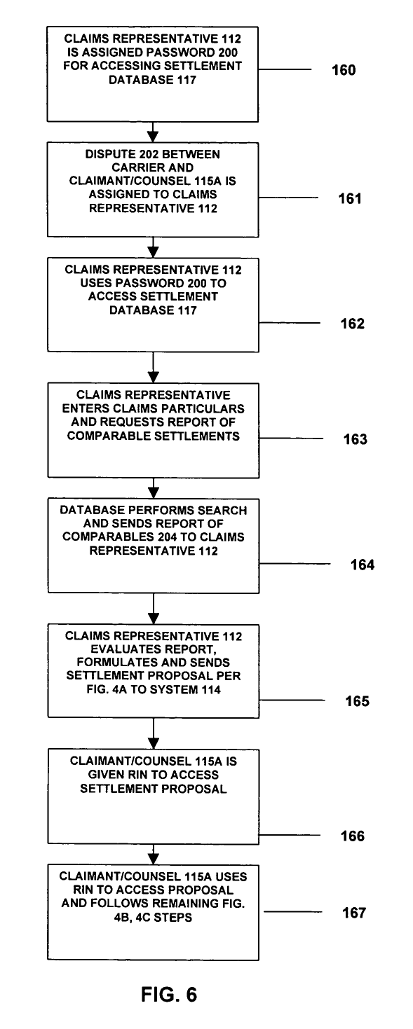

FIG. 4, FIGS. 4A, 4B and 4C being taken together, illustrates the steps in the practice of the present invention from initial transmission of a settlement proposal with respect to a first dispute through completion of the settlement process and storage of the settlement particulars for the dispute in a database with the subsequent accessing by database subscribers of the database in which the details of settlements previously processed by the system have been stored to obtain the details of comparable settlements processed by the system for purposes of evaluating a second dispute. In FIG. 4, it is assumed either that the claims representative 112 and the claimant/counsel 115 have reached a tentative agreement as to a settlement of a claim, involving the disbursal of funds on behalf of the carrier and the execution of a release (“Release”) as to the claim by the claimant/counsel 115, or that the claims representative 112 wishes to propose such a settlement to the claimant/counsel 115 involving such terms.

FIG. 4A is an overview in block diagram format of the system 110 interface, illustrating two alternative methods for the claims representative 112, in the practice of the present invention, to communicate the proposed settlement details to the independent third party for generation of a Release Identification Number (“RIN”) to be utilized in the processing of a settlement according to the method of the present invention. The claims representative 112 either inputs the settlement information into the carrier's claims system 113 and the carrier's claims system 113 accesses the third party system 114 through the secure site 111 and transmits the settlement information, normally including a release and matching criteria, or the claims representative directly accesses the third party's system 114, and transmits the settlement information via a secure connection, such as the site 111.

The claims representative 112 communicates the settlement information to the system 114 in either of two ways, by entering the settlement information into the carrier's claims system 113, as illustrated by Block 120 which transmits the settlement information to the third party's system 114 through a secure connection, such as the site 111, Block 121, or by accessing the system 114, such as via a secure network site, Block 122, and transmitting the settlement information directly to the third party's system 114, Block 123. The claims representative 112 or the carrier's claims system 113 input specific information about the claim, Block 122, which will be used for matching/verification purposes by the system 114 when claimant/counsel 115 accesses the system 114 through a designated secure network connection, site 111. The third party system 114 gathers the appropriate data, including the proposed settlement terms, participants, and such other information as may have been transmitted with respect to the settlement that will be used to match or verify information supplied by the claimant/counsel 115 when the claimant/counsel 115 accesses the third party system 114, and, after gathering this information, generates the RIN for the proposed settlement terms and parties, Block 124. In the preferred embodiment, the system 114 transmits the RIN to the claims representative 112 who in turn provides it to the claimant/counsel 115, Block 125, although the system 114 can, if authorized, transmit the RIN directly to the claimant/counsel 115 within the scope of the present invention. If the RIN is transmitted to the claims representative 112 and not the claimant/counsel 115 by the system 114, the claims representative then transmits the required access information, including the RIN, to the claimant/counsel 115, Block 126, to enable the claimant/counsel 115 to access the proposed settlement terms from the system 114 through link to the secure network site 111.

Referring now to FIG. 4B, after the claimant/counsel 115 receives the RIN, claimant/counsel 115 accesses the system 114, Block 127, and submits the RIN through a secure network connection to the system for verification in order to obtain access to the proposed settlement, Block 128. If the RIN supplied by the claimant/counsel is invalid, the system 114 denies access to the proposed settlement to the claimant/counsel 115, Block 129. If the RIN supplied by the claimant/counsel 115 is valid, the system grants claimant/counsel 115 access to the proposed settlement via the RIN, Block 130. If access is granted to the claimant/counsel 115, the system 114 requires claimant/counsel 115 to enter, verify and/or edit certain statistical and/or other data pertaining to the claim that is to be settled, Block 131, which the system 114 requires in order to complete the settlement processing. If claimant/counsel 115 does not provide the required information, the system 114 does not proceed further with the settlement processing, and requests confirmation from the claimant/counsel 115 that the online processing of the settlement is being cancelled, Block 132. If cancellation is confirmed or the clamant/counsel 115 does not respond, the system terminates the settlement processing and notifies the claims representative 112 of the termination, Block 133. If the claimant/counsel 115 complies with the requirement that the required information be entered, verified and/or edited, Block 134, the system 114 provides the claimant/counsel 115 with a network link to the Release, Block 135.

Referring now to FIG. 4C, claimant/counsel 115 accesses the Release, Block 136, and must electronically execute the Release in order to proceed with the settlement. If the Release is not executed, the system 114 advises claimant/counsel 115 that the online processing of the settlement will be cancelled for failure to execute the Release, Block 137, and asks claimant/counsel 115 to confirm cancellation, Block 138. If cancellation is confirmed or claimant/counsel 115 does not respond, the system 114 cancels the processing of the settlement and notifies the claims representative 112 of the cancellation, Block 139. If the Release is executed, Block 140, the system 114 transfers funds from the carrier or its designated source of funds to the claimant/counsel 115 according to electronic funds transfer information previously provided, Block 141. After the electronic funds transfer is initiated by the system 114, the system 114 notifies the carrier or the claims representative 112 that the online settlement has been completed, preferably together with a copy of the electronically executed Release, Block 142, deactivates the RIN, Block 143, and transmits the statistically relevant details as to the settlement to the database 117, Block 144. The database 117, which is a compilation of the statistically relevant information as to all of the completed settlements processed by the system 114, is updated with this information, Block 145.

FIG. 5 illustrates, in block diagram form, the steps of a further aspect of the present invention, the availability of the database 117 statistical information to the subscribers 118 through the secure network connection 119. Subscribers 118 to the database 117 are given a log in password or identification code, by the use of which the subscriber 118 can access the database 117 through the secure network 119, Block 146. The subscriber 118 submits the password to access the database 117, Block 147. If password information is invalid, the database generates an error message and access is denied, Block 148. If the subscriber 117 provides valid password log in information, the database 117 permits the subscriber 118 access to have a search performed of the settlement data in the database 117, Block 149. The subscriber 118 supplies statistically relevant information about a case to be evaluated, Block 150. The information supplied by the subscriber 118 is compared to relevant statistical settlement information already contained in the database 117, Block 151. A report of the results of the comparison is generated and transmitted to the subscriber 118, Block 152.

The subscriber 118 then either requests to terminate the access to the database 117 and the connection of the subscriber 118 is terminated, Block 153, or requests evaluation of another case and supplies statistically relevant information as to the different case to the database 117, Block 154, and the steps of the aspect of the present invention illustrated in FIG. 4D are repeated, or, preferably, initiates a proposed settlement of the dispute, after evaluating the settlement value of the dispute, Block 155, based, at least in part on the report of comparables from the database 117, by the practice of the present invention in its overall aspects by commencing the “inter partes” phase of the settlement process through the system 114 by initiating the steps illustrated in FIG. 4A, and continuing through the steps of FIG. 4B and FIG. 4C, thereby reaching at least the step illustrated as Block 145 in FIG. 4D if a settlement is consummated. This overall interrelationship of the steps of the present invention illustrated in FIG. 4 and FIG. 5 are illustrated in block diagram form in FIG. 6.

FIG. 6 illustrates the practice of the present invention in the context of the insurance claims representative 112 previously utilized with respect to the illustration of the practice of the aspects of the invention referred to in FIG. 4. Referring now to FIG. 6, assume for the purposes of illustration that the subscriber 118 is the claims representative 112, to whom a password 200 for accessing the database 117 has been assigned by the system 114, Block 160, that a new disputed claim for damages 202 between the carrier and a claimant/counsel 115A has arisen and has been assigned by the carrier to claims representative 112, Block 161. In order to better evaluate the claim as to its settlement value, the claims representative 112 accesses the settlement database 117 by using the password 200, Block 162, and enters the claim Particulars known to the claims representative 112 into the database 117 through the system 114 and requests a search report of settlements of other disputes involving comparable claim Particulars, Block 163. The database 117, in this embodiment of the present invention, performs the requested search and supplies the claims representative 112 with a search report 204, Block 164. The claims representative 112 evaluates the search report of comparables and formulates a proposed settlement 206 of the dispute 202, and, either before or after conferring with the claimant/counsel 115A, submits the settlement proposal 206 to the system 111 through either of the procedures set out with respect to the description of FIG. 4A, Block 165. The claimant/counsel 115A is given the RIN, Block 166, and the settlement proposal 206 is accessed by the claimant/counsel 115A by using the RIN according to the steps set out with respect to FIG. 4, and follows the remaining steps as set out with respect to FIG. 4 in the attempt to resolve the dispute 202, Block 167.

The utility of the database 117 in assisting in the evaluation of the settlement value of a dispute is principally dependent on the extent of the details contained in the database 117 for matching purposes as to the participants and the injuries giving rise to the current dispute as compared to the settled disputes. Therefore, the proprietor of the database 117 seeks to obtain as many details as to a given claim as can be obtained, in order that the scope of the “comparables” it finds may be as narrow as possible. Consequently, for a personal injury claim, for example, in order to maximize the efficiency of the search of the database 117, its proprietor seeks to obtain as much of the following information (the “claim Particulars”) as can be acquired from the parties to the dispute or their representatives, such as:
a. Claimant's age
b. Claimant's sex
c. Highest level of education completed
d. Marital status
e. Total number of marriages, if any
f. Number of dependent children, if any
g. Country of birth
h. Venue(s)
i. Anatomical injury area using an anatomical chart
j. Whether or not there was a prior injury to the same anatomical area
k. If prior injury to same anatomical area, how many months before the incident in question did it occur
l. Hospital stays, if any, and number of nights for each stay
m. Number of invasive procedures, if any
n. If any invasive procedures, type of anesthesia used
o. Medical bills for all:
   i. Emergency Rooms and Hospitals
   ii. Diagnostic Tests outside hospitals
   iii. Non-hospital treatments
p. Whether or not claimant received prescription drugs as a result of the accident
q. Disability paid or agreed to be paid
   i. Whether disability has been classified as permanent or temporary
   ii. Whether disability has been classified as partial or total
r. Number of defendants that are corporations
s. Whether or not claimant was employed full time at the time of the accident
t. Any claim for lost wages
   i. Number of days claimed
u. Any visible scars attributable to the accident
v. Whether or not there was any claim of brain injury
w. Whether or not there was a wrongful death claim
x. Whether the claimant was convicted of a crime as a result of the incident giving rise to the claim
y. Whether the insured was convicted of a crime as a result of the incident giving rise to the claim.

This information can be obtained, at least in part, from the claimant/counsel 115 and, in the first instance, from the claims representative 112. Therefore, in the currently preferred embodiment of the present invention, the claims representative is required to supply the above information, to the extent known, to the database system 114 in order to obtain the generation of the RIN, and the claimant/representative 115 is required to verify or edit the information supplied by the claims representative 112 and supply any missing information before electronically executing the Release and obtaining the settlement funds. The database 117 proprietor, in one embodiment of the present invention, conditions the consummation of the settlement on the requested information being supplied. Typically, such information is processed by the database 117 proprietor so that the parties to the settlement, carrier, source and destination of the settlement funds, and other sensitive personal or confidential information are not accessible from the database 117, and, preferably, are stripped from the settlement information before it is retained in the database 117.

Thus, in the presently preferred embodiment of the present invention illustrated in FIG. 4, the claims representative 112 preferably obtains a report of comparables by supplying as much of the claim Particulars as are available to the system 114 in order to obtain the comparables report and ultimately, the generation of the RIN. The claims representative 112, after reaching a valuation of the dispute for settlement purposes, provides the proposed settlement details to the system 114 to obtain the generation of the RIN, and provides the claimant/counsel 115 with the RIN, over the telephone only for example, for security purposes, along with a network link to enable the claimant/counsel 115 to access the system 114 through the secure network 111 by using the RIN. The claimant/counsel 115 accesses the system 114 using the link and the system 114 requires the claimant/counsel 115 to provide the following:
a. the RIN
b. Claimant/counsel's name
c. if claimant is represented by counsel, the counsel's name and any firm name
d. an E-mail address or other address for settlement verification purposes
e. address of claimant/counsel, and
f. federal tax identification number of counsel or Social Security Number of claimant for tax purposes.

After claimant/counsel 115 submits this information, the system 114 checks the information against the information supplied by the claims representative 112. If the RIN or other matching criteria, such as claimant's or claimant's counsel's name or address are do not match, further access to the RIN by claimant/counsel 115 is denied, and, preferably, an error message is generated and sent to claimant/counsel 115 and the claims representative 112 is notified that there has been an unauthorized attempt to access the RIN. Unless the error is corrected, the system 114 terminates the connection to the system 114 by the claimant/counsel 115.

If the RIN and other matching criteria entered by the claimant/counsel 115 are validated, the system 114 requires the claimant/counsel 115 to provide the system 114 with statistically relevant, non-identifying information, such as may be included in the claim Particulars, in order to proceed with the online processing of the settlement. If the claimant/counsel 115 does not provide the information to the system 114 or requests that the online processing be terminated, the system 114 will request confirmation from the claimant/counsel 115 of the termination of the online processing by reason of failure to provide the claim Particulars and, unless the claim Particulars are forthcoming from the claimant/counsel 115, the system 114 terminates the online processing of the settlement and notifies the claims representative 112 that claimant/counsel has failed to provide the claim Particulars and that online processing of the settlement has terminated.

If claimant/counsel provides the statistical data requested, the system 114 transmits certain statistically relevant data with respect to the claim Particulars (which is to be stored in the database 117) to the claimant/counsel 115 and requests claimant/counsel 115 to verify and/or edit the data and/or supply additional data. When claimant/counsel 115 has completed the verification and/or editing of the data, the system 114 provides claimant/counsel 115 with an electronic link to the Release for the claim being settled, which claimant/counsel utilizes to access the Release. In order to consummate the settlement, the system 114 requires the claimant/counsel 115 to accept the Release by executing it by means of an electronic signature verification. If the claimant/counsel 115 does not execute the Release, the system 114 notifies the claimant/counsel 115 that online processing of the claim settlement is being cancelled and notifies the claims representative 112 that on line processing of the claim settlement has ben terminated for failure of the claimant/counsel 115 to execute the Release.

If claimant/counsel 115 executes an electronic signature verification for the Release, the system 114 electronically transmits copies of the executed Release to claimant/counsel 115 and the claims representative 112 and requests the claims representative 112 and/or the claimant/counsel 115, if the necessary information has not already been provided, to provide the system 114 with the information as to the funds source and funds recipient required for the electronic transfer the settlement funds, such as the following according to the current practice of electronic funds transfers:
a. Taxpayer Identification Number or Social Security Number
b. Bank Name
c. Bank Account Number
d. Bank Routing Number (ABA Number)
e. Account Name

When the system 114 has received the information necessary to initiate the electronic funds transfer, the system 114 initiates the electronic transfer of the settlement funds in accordance with these instructions. The system 114 then verifies that the electronic funds transfer was initiated, notifies the claimant/counsel 115 of the transfer verification, notifies the parties of the consummation of the settlement, deactivates the claim RIN, and transmits the claim Particulars and other settlement details deemed statistically significant by the database 117 proprietor, including the amount of the settlement, to the proprietary settlement database 117, for access by the database subscribers 118 in evaluating the settlement value of other claims, as will now be described.

Database subscribers 118 to the proprietary database 117 are provided with access identification codes or passwords to be used to access the database 117 through a network link. The passwords or codes are preferably supplied at the time of subscription, although, if desired, they are supplied later and/or on an individual access basis. The subscriber 118 accesses the system 114 using the network link and enters the password. The system 114 verifies that the password is valid, or otherwise generates an error message and terminates the access of the subscriber 118. If the password is valid, the system 114 requires the subscriber 118 to enter claim Particulars for the dispute to be analyzed for comparables, either in the system 114 itself or in the database 117, depending on how the present invention is programmed with respect to the system 114 and database 117. The database 117 settlement contents are searched for matching data points with respect to the claim Particulars and a report is generated and supplied to the subscriber 118 listing the settlement comparables. The settlement comparables give the subscriber 118 a likely settlement value range, based on the claim Particulars previously entered by the subscriber 118 and the information contained in the database 117 relating to specific data points for prior settlements. The subscriber 118, if desired, then enters additional claim Particulars for the claim, or deletes selected of the claim Particulars previously entered, and requests that the database 117 generate a new list of comparables for the subscriber 118 in order to determine the effect on the settlement value of specific claim Particulars. Alternatively, the subscriber 118 may terminate the access to the system 114, or submit one or more new sets of claim Particulars to in order to evaluate other disputes before terminating access to the system 114. Furthermore, it is obvious that the claim Particulars submitted need not relate to an actual claim, but rather may relate to a theoretical or potential claim in this aspect of the practice of the present invention.

The following steps are a detailed explanation of the practice of this aspect of the present invention, in which the system 114 utilizes a conventional computer which is accessed electronically over a global computer network, as, for example, the Internet, and in which commands are transmitted by conventional means, such as a keyboard and a “mouse” by “clicking” on the mouse, although any system for transmitting commands and data, whether electronic, electromechanical, or oral can be utilized. Thus, the use of the term “clicking” is by way of explanation, and not limitation, and it to be understood to include any such transmission means. After the party wishing to propose a settlement, assumed to be the claims representative 112, has taken such investigations as are deemed appropriate, preferably including consideration of a generation of a comparables report generated from information contained in the database 117, the claims representative 112 transmits the proposed settlement to the system 114 and a RIN is generated and transmitted to the claims representative 112, and the practice of the invention proceeds as follows:
a. The claims representative 112 gives claimant/counsel 115 the link for the network site 111 of the system 114, and the RIN.
b. Claimant/counsel 115 accesses the system 114 via the network site 111 using the link provided by the claims representative 112.
c. Claimant/counsel 115 reviews an instruction screen of the system 114 and inputs information as to one or more of the following, as required by the system 114:
   i. RIN
   ii. Claimant/counsel's name
   iii. If claimant is represented by counsel, the firm name
   iv. E-mail address for settlement verification purposes
   v. Location (city and state) of claimant/counsel 115
   vi. Taxpayer Number of counsel or Social Security Number of claimant.
   vii. Claimant/Counsel then clicks on “Continue”.
d. If the RIN and other matching criteria are valid, further access to the system 114 is permitted. If any of the matching criteria is invalid, further access to the system 114 is denied, an error message is displayed and the claims representative 112 is notified by the system 114 that there has been an unauthorized attempt to access the settlement. The system 114 logs off claimant/counsel 115.
e. If access is permitted, the system 114 requests claimant/counsel 115 to agree to provide, preferably for the exclusive use of the proprietor of the system database 117, with all or selected ones of the following settlement related data points (the “claim Particulars”) required to be supplied by claimant/counsel 115 in order to continue with the online processing of the settlement:
   i. Claimant's age
   ii. Claimant's sex
   iii. Highest level of education completed
   iv. Marital status
   v. Total number of marriages, if any
   vi. Number of dependent children, if any
   vii. Country of birth
   viii. Venue(s)
   ix. Anatomical injury area using an anatomical chart
   x. Whether or not there was a prior injury to the same anatomical area
   xi. If prior injury to same anatomical area, how many months before the incident in question did it occur
   xii. Hospital stays, if any, and number of nights for each stay
   xiii. Number of invasive procedures, if any
   xiv. If any invasive procedures, type of anesthesia used
   xv. Medical bills for all:
      a. Emergency Rooms and Hospitals
      b. Diagnostic Tests outside hospitals
      c. Non-hospital treatments
   xvi. Whether or not claimant received prescription drugs as a result of the accident or injury
   xvii. Disability paid or agreed to be paid
      a. Whether disability has been classified as permanent or temporary
      b. Whether disability has been classified as partial or total
   xviii. Number of defendants that are corporations
   xix. Whether or not claimant was employed full time at the time of the accident
   xx. Any claim for lost wages
      a. Number of days claimed
   xxi. Any visible scars attributable to the accident
   xxii. Whether or not there was any claim of brain injury
   xxiii. Whether or not there was a wrongful death claim
   xxiv. Whether the claimant was convicted of a crime as a result of the incident giving rise to the claim
   xv. Whether the insured was convicted of a crime as a result of the incident giving rise to the claim
f. If claimant/counsel 115 agrees, for each of these data points required by the system 114, claimant/counsel 115 must select a prompt such as “Verify” or a prompt such as “Edit”. If “Verify” is selected, the data will be downloaded into the database 117 unchanged. If “Edit” is selected, the data is corrected by the claimant/counsel 115 and verified by the claimant/counsel 115 prior to downloading to the database 117. If claimant/counsel 115 does not agree, online processing is terminated and the claims representative 112 is notified.
g. Claimant/counsel 115, after completing the editing and/or verification of the claim Particulars, selects a “Continue” or similar prompt, the claim Particulars are ready to be downloaded through the system 114 to the database 117, and the system 114 analyzes the claim Particulars to verify that they have been edited and/or verified.
h. If claimant/counsel 115 does not edit and/or verify the claim Particulars, or does not select “Continue,” the system 114 notifies claimant/counsel 115 that processing will terminate unless the required information is provided, and if not then provided, terminates the access of claimant/counsel 115 to the system 114 and notifies the claims representative 112 of the termination.
i. If the system 114 verifies that the claimant/counsel 115 has provided and verified the claims Particulars, the system 114 provides claimant/counsel 115 with means to access the terms of a proposed release by claimant/counsel 115 of all claims against the carrier relating to the dispute (Release), preferably in a PDF or a similar format, and the options of accepting or not accepting the Release.
j. Unless claimant/counsel 115 accepts the terms of the Release, the system informs claimant/counsel 115 that online processing of settlement will be terminated and requests claimant/counsel 115 to confirm cancellation. If confirmed, the claims representative 112 is notified that online processing of the settlement has been cancelled and the system 114 terminates the access of claimant/counsel 115 to the system 114.
k. If claimant/counsel 115 accepts the terms of the Release, claimant/counsel selects on a link provided by the system 114 to electronically sign the Release.
l. The claimant/counsel 115 electronically signs the Release and is requested to provide the system 114 with information requested by the system 114 in order to transfer the settlement funds, including one or more of the following:
   i. Taxpayer number or Social Security Number of recipient of settlement funds
   ii. Bank Name
   iii. Bank Account Number
   iv. Bank Routing Number (ABA Number)
   v. Account Name
m. Claimant/counsel 115 provides the required information, and selects a prompt such as “Submit.”
n. The system 114 display a confirmation number for the transaction to claimant/counsel 115, which claimant/counsel 115 can print out.
o. The system then initiates the electronic transfer of the settlement funds from an account designated by the carrier or the claims representative 112 to the account designated by the claimant/counsel 115.
p. The system 114 receives notification from the source of the settlement funds when the funds transfer has been initiated.
q. The system 114 sends an electronic message to the claims representative 112 and claimant/counsel 115 that the funds transfer has been initiated.
r. The system 114 edits the claim Particulars to remove any information identifying the participants in the settlement, sends the edited claim Particulars to the database 117, deactivates the RIN and closes its processing for that claim.
s. The database 117 adds the edited claim Particulars to its compilation of other claim Particulars already cataloged for other settlements processed by the system 114 so as to be accessible by database subscribers 118 on a selective basis, as heretofore described.

The foregoing detailed description of the practice of the presently preferred embodiment of the overall invention with respect to the settlement of a damage claim asserted by a claimant/counsel 115 with respect to a policy issued by a carrier is summarized as follows:
a. the carrier authorizes its claims representative 112 to investigate the claim;
b. the claims representative 112 accesses a computerized system 114 which can access a proprietary database 117 containing a compilation of details of prior settlements of insurance claims and is capable of comparing details of the claim against details of prior claim settlements in order to generate a report as to comparable claim settlements;
c. the claims representative 112 submits claim details to the system 114 and requests generation of a comparables report from the prior settlements of insurance claims information;
d. the database 117 generates the comparables report and transmits it to the claims representative 112;
e. the claims representative 112 formulates a proposed settlement;
f. the claims representative transmits the settlement proposal to the system 114, together with identity information as to the claimant/counsel 115 for use by the system 114 in authorizing access by the claimant/counsel 115 to the settlement proposal;
g. the system 114 generates a unique designator for the proposed settlement by use of which the claimant/counsel 115 can access the proposed settlement by a link to the system 114;
h. the unique designator and the system link is provided to the claimant/counsel 115;
i. the claimant/counsel 115 accesses the system 114 by using the link provided by the claims representative 112 and provides the unique designator and information to confirm the identity information supplied by the claims representative 112 before the system 114 permits access to the settlement proposal by use of the unique designator;
j. the system 114 verifies the identity information supplied by the claimant/counsel 115 and permits access to the settlement proposal by the claimant/counsel 115 by use of the unique designator;
k. after access is permitted, the system 114 requires claimant/counsel 115 to provide the system database 117 with specified settlement related data pertaining to the claim being settled;
l. the claimant/counsel 115 supplies the specified settlement related data;
m. the system 114 verifies that the claimant/counsel 115 has provided the specified settlement related data;
n. the system 114 provides claimant/counsel 115 with means to access the proposed settlement and the option of accepting the proposed settlement;
o. the claimant/counsel 115 accepts the terms of the proposed settlement;
p. the system 114 provides claimant/counsel 115 with a link to electronically sign the proposed settlement;
q. the claimant/counsel 115 electronically signs the proposed settlement and provides the system 114 with information required to transfer the settlement funds;
r. the system 114 display a confirmation number for the transaction to claimant/counsel 115;
s. the system 114 initiates the electronic transfer of the settlement funds from an account designated by the carrier or the claims representative 112 to an account designated by the claimant/counsel 115.
t. the system 114 receives notification from the source of the settlement funds when the funds transfer has been initiated;
u. the system 114 sends an electronic message to one or both of the claims representative 112 and claimant/counsel 115 that the funds transfer has been initiated;
v. the system 114 edits the specified settlement data to remove any information identifying the participants in the settlement;
w. the system 114 sends the edited specified settlement data to the database 117 and deactivates the unique designator; and
x. the edited specified settlement data is added to the details of prior settlements of insurance claims compilation of the database 117 so as to be accessible by database subscribers 118 on a selective basis.

However, the use of the database 117 by the database subscribers 118 is not limited to the implementation of all of the steps set out in FIG. 4 as specifically set out above. For example, a proposed settlement may be transmitted to the system 114 by a subscribing counsel/claimant rather than by a claims representative or carrier, in which event the roles set out with respect to FIG. 4 are essentially reversed, except for the source and recipient of the settlement funds and the party executing the Release. Furthermore, in the process of resolution of a dispute, it is not necessary that the party utilizing the proprietary database 117 to assist in the evaluation of the settlement value of the dispute actually do more than obtain the search report of the “comparables,” at least at the time the report is received or evaluated. The search report recipient, after having practiced that aspect of the present invention, may, for whatever reason deemed appropriate, make no further use of the report, or communicate with respect to the opposing party other than by means of utilization of other aspects of or steps in the overall method of the present invention, so that the scope of the invention is not to be understood to be limited to the specific examples set out herein by way of explanation, but rather only by the claims hereof, as will be understood by those skilled in the art.

Consequently, the presently preferred embodiments of the invention have been set forth herein in detail for illustrative purposes only, and it will be apparent to those skilled in the art that variations and modifications thereof, including the rearrangement, addition and/or elimination of steps, lie within the scope of the present invention, which is not limited to the specific sequences of the steps of the specific embodiments illustrated or described herein, but only by the scope of the following claims.

1. In a method for settling disputes, the steps of:
a first party to a dispute between the first party and a second party communicating to a third party details as to a settlement of a dispute to be funded by a disbursal of funds;
the third party assigning a unique identifying designator to the settlement details;
making the settlement details available for electronic access from the third party by the second party by use of the designator and communicating the designator to the second party;
the second party using the designator to electronically access the settlement terms;
the second party electronically transmitting either a settlement terms acceptance communication or a settlement terms rejection communication to the third party; and
the third party, after receiving the acceptance communication or the rejection communication, either causing the settlement to be funded by commencing an electronic funds transfer from a designated source if the communication is an acceptance communication and notifying the parties of the acceptance and funds disbursal commencement, or, if the communication is a rejection communication, notifying the first party of the receipt of the rejection.

2. The method of claim 1, and including the step of the third party, subsequent to receipt of an acceptance communication, transferring selected information as to the dispute and its settlement details to a database adapted to accumulate selected information as to disputes and their settlement details.

3. The method of claim 2, and in which the database is maintained by the third party, and including the step of the third party making the accumulated selected details contained in the database available for access on a selective basis.

4. The method of claim 3, and in which the selective basis includes the step of the third party causing a report of selected ones of the settlement details accumulated in the database to be generated and transmitted to a fourth party, in response to a request from said fourth party for a report containing settlement details relating to disputes having facts comparable to facts supplied by said fourth party in requesting the report.

5. The method of claim 4, and in which the fourth party is the same as either the first party or the second party.

6. In a method for resolving a dispute between a first party and a second party through the use of a computer system, and in which the first party has prepared a proposed settlement and transmitted the proposed settlement to the system, the steps of:
a. the first party providing the second party with a link for a network site to be used for access to the system and a unique designator for accessing the system;
b. the second party accessing the system via the network site using the link;
c. the second party supplying identifying information required by the system for further access to the system;
d. the system verifying the identifying information and, if correct, permitting further access to the system by the second party, or, if incorrect, denying further access to the system to the second party until correct identifying information is supplied; and
e. if further access is permitted,
i. the system providing the second party with means to access the terms of a settlement and the options of accepting or not accepting the terms and requiring the second party to agree to supply settlement related data to the system if the settlement terms are accepted;
ii. the system terminating the second party's access if the second party does not agree to accept the settlement terms and supply the settlement related data;
iii. if the second party agrees to accepts the settlement terms and supply the settlement related data, the system supplying the second party with a link for the second party to electronically sign the settlement terms;
iv. the second party electronically signing the settlement terms and providing the system with settlement funds transfer information requested by the system;
v. the system sending a confirmation number for the transaction to second party and initiating the electronic transfer of the settlement funds; and
vi. the system sending an electronic message to at least one of the parties that the funds transfer has been initiated.

7. The method of claim 6, and including the step of the system, subsequent to receipt of an acceptance communication, transferring selected information as to the dispute and its settlement terms to a database adapted to accumulate selected information as to disputes and their settlement terms.

8. The method of claim 7, and including the step of the system making the accumulated selected terms contained in the database available for access by parties, irrespective of whether such party has participated in settlements as to which selected information has been accumulated in the database, on a selective basis.

9. The method of claim 8, and in which the selective basis includes the steps of a party requesting the system to provide a report containing settlement information relating to disputes having facts comparable to facts supplied by said party in requesting said report; and the system causing a report of selected ones of the settlement information accumulated in the database and having facts comparable to facts supplied by said party in requesting the report to be generated and transmitted to said party in response to said request.

10. A system for assisting in evaluating a claim by a first party against a second party comprising:
a. accumulating the selected details of claim settlements in a database;
b. permitting access to the database through a computerized program to a database subscriber to request an evaluation of the claim;
c. requiring the database subscriber to supply a plurality of specific details as to the claim to the program;
d. generating a search report by the program of settlements contained in the database involving selected details comparable to the specific details supplied by the subscriber; and
e. transmitting the search report to the database subscriber for use by the first party in evaluating the claim.

11. A method for attempting to resolve a claim by a first party against a second party comprising the steps of:
a. providing a database in which selected details of claim settlements are to be accumulated and which may be accessed by database subscribers;
b. accumulating selected details of claim settlements in the database;
c. permitting access to the database through a computerized program to a database subscriber to request an evaluation of the claim;
d. requiring the database subscriber to supply a plurality of specific details as to the claim to the program in order to obtain the claim evaluation;
e. generating a search report by the program of settlements contained in the database involving selected details comparable to certain of the specific details supplied by the subscriber;
f. transmitting the search report to the database subscriber for use by the first party in preparing a proposed settlement of the claim;
g. preparing a proposed settlement by the first party of the claim utilizing the search report; and
h. transmitting the proposed settlement to the second party.

12. The method of claim 11, and in which the step of transmitting the settlement proposal to the second party comprises the first party transmitting the settlement proposal to an independent third party, and the third party transmitting the settlement proposal to the second party.

13. A method according to claim 12, and in which the database is maintained by the third party.

14. In a method for resolving a dispute between a first party and a second party through the use of a computer system, and in which the first party has prepared a proposed settlement which requires a transfer of settlement funds and transmitted the proposed settlement to the system, the steps of:
a. providing the second party with a link for a network site of the system and a unique designator for accessing the system through the site by using the link;
b. the second party accessing the system via the network site using the link;
c. the second party supplying identifying information required by the system to the system to attempt to access the proposed settlement;
d. the system verifying the identifying information and, if correct, permitting further access to the proposed settlement by the second party, or, if incorrect, denying further access to the proposed settlement to the second party until correct identifying information is supplied and verified; and
e. upon correct identifying information being supplied and verified, the system requiring the second party to supply settlement related data to the system in order to continue further access to the proposed settlement;
i. upon the settlement related data being supplied, the system providing the second party with means to access terms of the proposed settlement and the options of accepting or not accepting the settlement terms, and terminating the second party access to the proposed settlement if the terms are not accepted;
ii. upon second party accepting the settlement terms, the system providing a link for the second party to electronically sign the settlement terms and terminating access to the settlement terms if the second party does not electronically sign the settlement terms using the link;
iii. upon the terms being electronically signed, the system requiring the second party to provide the system with information requested by the system in order to transfer the settlement funds if not already provided; and
iv. the system initiating the electronic transfer of the settlement funds and sending an electronic message to at least one of the parties that the funds transfer has been initiated.

15. A method for the disposition of claims asserted between first parties and second parties comprising the steps of:
a. an independent third party accumulating selected details of claim settlements in a database;
b. the independent party permitting selective access to a database subscriber to request an evaluation of a claim;
c. the independent party requiring the database subscriber to supply a plurality of specific details as to the claim to be evaluated in order to obtain the claim evaluation;
d. the database subscriber supplying the plurality of specific details as to the claim to be evaluated;
e. the independent party causing the database to be searched for settlements contained in the database having details generally comparable to the plurality of specific details;
f. the independent party causing the generation of a search report of the settlements contained in the database having details generally comparable to at least some of the plurality of specific details supplied by the database subscriber;
h. the independent party causing the transmission of the search report to the database subscriber for use by the first party;
i. the first party preparing a proposed settlement which is based, at least in part, on the search report and which involves the transfer of settlement funds;
j. the first party transmitting the proposed settlement to the independent party;
j. assigning a unique designator to the settlement proposal;
k. providing a second party with a link fora network site maintained by the independent party and the unique designator for accessing the proposed settlement through the site by using the link;
l. the second party accessing the network site by using the link;
m. the second party supplying identifying information required by the independent party to access the proposed settlement;
n. the independent party verifying the identifying information and, if correct, permitting further access to the proposed settlement by the second party, or, if incorrect, denying further access to the proposed settlement to the second party until correct identifying information is supplied and verified;
o. upon correct identifying information being supplied and verified, the independent party requiring the second party to supply settlement related data in order to continue further access to the proposed settlement;
i. upon the settlement related data being supplied, the independent party providing the second party with means to access terms of the proposed settlement and the options of accepting or not accepting the settlement terms, and terminating the second party access to the proposed settlement if the terms are not accepted;
ii. upon second party accepting the settlement terms, the independent party providing a link for the second party to electronically sign the settlement terms and terminating access to the settlement terms if the second party does not electronically sign the settlement terms using the link;
iii. upon the terms being electronically signed, the independent party requiring the second party to provide information required in order to transfer the settlement funds if not already provided; and
iv. the independent party initiating the electronic transfer of the settlement funds and sending an electronic message to at least one of the first and second parties that the funds transfer has been initiated; and
p. the independent party transmitting selected details of the settlement terms to the database for use selectively in generating search reports subsequently.

16. A method for assisting in evaluating a claim asserted by a claimant with respect to an insurance policy issued by an insurer comprising the steps of:
a. an independent party accumulating selected details of insurance claim settlements in a database;
b. the independent party permitting selective access over a secure network to a database subscriber to request an evaluation of the claim;
c. the independent party requiring the database subscriber to supply a plurality of specific details as to the claim to be evaluated in order to obtain the claim evaluation;
d. the database subscriber supplying the plurality of specific details as to the claim to be evaluated;
e. the independent party causing the database to be searched for settlements contained in the database having details generally comparable to the plurality of specific details;
f. the independent party causing the generation of a search report of the settlements contained in the database having details generally comparable to the plurality of specific details supplied by the subscriber; and
h. the independent party causing the transmission of the search report to the database subscriber over the secure network.

17. A method for settling claims asserted by claimant/counsel with respect to an insurance policy issued by an insurance carrier comprising the steps of:
a. the carrier authorizing a claims representative 112 to investigate settlement of the claim;
b. the claims representative accessing a computerized system 114 which can access a proprietary database 117 containing a compilation of details of prior settlements of insurance claims and is capable of comparing details of the claim against details of prior claim settlements in order to generate a report as to comparable claim settlements;
c. the claims representative 112 submitting claim details to the system 114 and requesting generation of a comparables report from the prior settlements of insurance claims information;
d. the database 117 generating the comparables report and transmitting it to the claims representative 112;
e. the claims representative 112 formulating a proposed settlement based, at least in part, on the comparables report;
f. the claims representative 112 transmitting the settlement proposal to the system 114, together with identity information as to a claimant/counsel 115 for use by the system 114 in authorizing access by the claimant/counsel 115 to the settlement proposal;
g. the system 114 generating a unique designator for the proposed settlement by which the claimant/counsel 115 can access the proposed settlement by a link to the system 114;
h. the unique designator and the system link is provided to the claimant/counsel 115;
i. the claimant/counsel 115 accessing the system 114 by using the link provided by the claims representative 112 and providing the unique designator and information to confirm the identity information supplied by the claims representative 112 before the system 114 permits access to the settlement proposal by use of the unique designator;
j. the system 114 verifying the identity information supplied by the claimant/counsel 115 and permitting access to the settlement proposal by the claimant/counsel 115 by use of the unique designator;
k. after access is permitted, the system 114 requiring claimant/counsel 115 to supply specified settlement related data pertaining to the claim being settled to the system database 117;
l. the claimant/counsel 115 supplying the specified settlement related data;
m. the system 114 verifying that the claimant/counsel 115 has provided the specified settlement related data;
n. the system 114 providing claimant/counsel 115 with means to access the proposed settlement and the options of accepting or not accepting the settlement proposed settlement;
o. the claimant/counsel 115 accepting the terms of the proposed settlement;
p. the system 114 providing claimant/counsel 115 with a link to electronically sign the proposed settlement;
q. the claimant/counsel 115 electronically signing the proposed settlement and providing the system 114 with information required to transfer the settlement funds;
r. the system 114 providing a confirmation number for the transaction to claimant/counsel 115;
s. the system 114 initiating the electronic transfer of the settlement funds from an account designated by the carrier or the claims representative 112 to an account designated by the claimant/counsel 115.
t. the system 114 receiving notification from the source of the settlement funds when the funds transfer has been initiated;
u. the system 114 sending an electronic message to one or both of the claims representative 112 and claimant/counsel 115 that the funds transfer has been initiated;
v. the system 114 editing the specified settlement data to remove any information identifying the participants in the settlement,
w. the system 114 sending the edited specified settlement data to the database 117 and deactivating the unique designator; and
x. the edited specified settlement data is added to the details of prior settlements of insurance claims compilation of the database 117 so as to be subsequently accessible by database subscribers 118 on a selective basis for claim evaluation and settlement proposal formulation purposes.
